(19) United States
(12) Patent Application Publication
(10) Pub. No.: US 2012/0077045 A1
(43) Pub. Date: Mar. 29, 2012

(54) SOIL RESISTANT CLEANER AND SURFACE TREATMENT

(75) Inventors: Kim R. Smith, Woodbury, MN (US); Erik C. Olson, Savage, MN (US); Keith E. Olson, Apple Valley, MN (US); Steven E. Lentsch, St. Paul, MN (US); Minyu Li, Oakdale, MN (US); Catherine Hanson, Hastings, MN (US); Andrew Wold, St. Louis Park, MN (US)

(73) Assignee: ECOLAB USA INC., St. Paul, MN (US)

(21) Appl. No.: 13/304,846

(22) Filed: Nov. 28, 2011

Related U.S. Application Data
(63) Continuation-in-part of application No. 12/617,121, filed on Nov. 12, 2009.
(60) Provisional application No. 61/422,278, filed on Dec. 13, 2010.
(60) Provisional application No. 61/422,280, filed on Dec. 13, 2010.
(60) Provisional application No. 61/422,282, filed on Dec. 13, 2010.

(51) Int. Cl. B32B 27/30; C08L 33/02; B32B 17/10; B32B 18/00; B05C 5/00; B32B 13/00; B32B 15/08; B05D 3/02; B05D 3/00; C11D 3/37; B32B 25/08

(52) U.S. Cl. 428/442; 510/400; 524/556; 428/522; 428/451; 428/463; 428/492; 427/385.5; 427/352; 118/300

(57) ABSTRACT

A soil resistant laminate composition and a soil resistant treatment use composition are provided. In particular, a laminate composition comprising a multilayer composition of a clean or soiled surface and a dried layer of a soil resistant agent are disclosed. Soil resistant agents according to the invention include copolymers of a maleic/olefin, an olefin/acrylate and combinations thereof and are suitable for delivery with a detergent carrier. A kit and methods for treating a clean or soiled surface using a soil resistant laminate composition and a soil resistant treatment use composition are provided by the present invention.

### CROSS-REFERENCE TO RELATED APPLICATIONS

This application claims priority and is related to U.S. Provisional Application Ser. No. 61/422,282 (Attorney Docket Number 2769USP1) filed on Dec. 13, 2010 and entitled Soil Resistant Surface Treatment, U.S. Provisional Application Ser. No. 61/422,278 (Attorney Docket Number 2830USP1) filed on Dec. 13, 2010 and entitled Acrylate-Olefin Copolymers as Soil Resistant Surface Treatment, and U.S. Provisional Application Ser. No. 61/422,280 (Attorney Docket Number 2831USP1) filed on Dec. 13, 2010 and entitled Acrylates as Soil Resistant Surface Treatment. The entire contents of these patent applications are hereby expressly incorporated herein by reference including, without limitation, the specification, claims, and abstract, as well as any figures, tables, or drawings thereof.

This application is a continuation-in-part application of U.S. application Ser. No. 12/617,121 (Attorney Docket Number 2586US01) filed on Nov. 12, 2009, entitled Composition and Method for Removal of Polymerized Non-Trans Fats. The entire contents of this patent application are hereby expressly incorporated herein by reference including, without limitation, the specification, claims, and abstract, as well as any figures, tables, or drawings thereof.

This application is related to U.S. patent application Ser. No. ______ (Attorney Docket Numbers 2815USP1 and 2815USU1), entitled Stain Resistant Floor Treatment, and U.S. patent application Ser. No. ______ (Attorney Docket Numbers 2816USP1 and 2816USU1), entitled Soil Resistant Floor Treatment, filed simultaneously herewith. The entire contents of these patent applications are hereby expressly incorporated herein by reference including, without limitation, the specification, claims, and abstract, as well as any figures, tables, or drawings thereof.

### FIELD OF THE INVENTION

The invention relates to soil resistant surface treatments. In particular, soil resistant laminate compositions are formed using soil resistant treatment compositions according to the invention. The soil resistant treatment compositions comprise polymers and/or copolymers and a detergent carrier. Kits and methods of cleaning and/or treating surfaces using the soil resistant treatment compositions and laminate compositions are provided for use on a variety of surfaces.

### BACKGROUND OF THE INVENTION

Many compositions have been developed for cleaning or coating hard non-porous surfaces. Cleaning compositions often incorporate soil release agents, such as non-surfactant additives applied to a soiled surface as part of a detergent in order to improve soil removal capability of a detergent. Soil release agents are effective by decreasing lubricity of a soiled surface in order to enhance soil removal through mechanical action. Soil release agents are intended for application to soiled surfaces, as application to clean surfaces counterproductively results in attracting soil, causing the surface to become soiled again at a faster rate. These prior art uses of soil release agents depend upon the change in soiled surfaces and requiring continued use for each new soil on a surface. Often they employ detergents for additional cleaning efficacy, rather than forming an evenly distributed laminate surface for soil resistance as accomplished by the present invention.

In addition to the difficulty of cleaning hard, non-porous surfaces, once cleaned, it may be difficult to maintain the appearance of the cleaned surface in a satisfactory state. Imparting soil resistance to a clean surface is therefore desirable. Soil resistance is distinct from soil release and acts to minimizes or prevent the adhesion of soil to a treated clean surface.

It is an objective of the claimed invention to develop a soil resistant surface treatment for improved soil resistance and cleaning of surfaces, including porous and/or non-porous surfaces. According to the invention, the soil resistant surface impairs the binding of soil through an intermediary polymer layer which makes it difficult for oily materials to wet the surface and enhances the wetting of water.

A further object of the invention is a novel polymeric treatment composition, including soil resistant agents that are polymers and/or copolymers, preferably with a detergent composition carrier for even distribution across a treated surface, and methods of using the same to impart soil resistance to a surface, such as a soil or clean surface.

A further object of the invention is to provide a method of treating soiled and/or clean surfaces to prevent soils and limit or eliminate adherence to the surfaces.

### BRIEF SUMMARY OF THE INVENTION

In one embodiment of the present invention, a soil resistant laminate composition is provided. The composition includes a multilayer composition of a clean or soiled surface and a dried layer, wherein an aqueous solution is applied to a surface to form the dried layer and said aqueous solution is from about 0.005 wt % to about 20 wt % of at least one soil resistant agent having a molecular weight from about 1,000 to about 20,000 g/mol, preferably from about 1,000 to 10,000 g/mol, and more preferably from about 2,000 to 5,000 g/mol, and still more preferably about approximately 3,000 g/mol. The at least one soil resistant agent is selected from copolymers from the group consisting of a maleic/olefin, an olefin/acrylate and combinations thereof and is provided in a detergent carrier to be applied to said clean or soiled surface. In an embodiment, the soil resistant agent is substantially free of fluorinated or silicone substituents and/or is modified such that no viscosity-building or threshold activity is exhibited.

In a further embodiment the oil/water contact angle ratio of the surface of a laminate formed from the copolymer and a treated substrate is at least 2, at least 4 or at least 6. In another embodiment, a soil resistant laminate composition includes a multilayer composition having an oil/water contact angle ratio of the laminate surface formed from the soil resistant agent and substrate of at least 2. The composition includes either a clean or soiled surface as a bottom layer and a dried layer of at least one soil resistant agent as a top layer, wherein said dried layer is formed from an aqueous solution of from about 0.1% to 5% soil resistant agent, and wherein said soil resistant agent has a molecular weight from about 1,000 to 20,000 g/mol and a detergent carrier.

In a further embodiment of the invention, a soil resistant laminate composition includes a soil release agent. The soil release agent is from between about 0.1% and about 20% by weight and comprises an olefin/acrylate copolymer.

In a further embodiment of the present invention, a soil resistant use (i.e. treatment) composition is provided. The composition includes a soil resistant agent selected from copolymers from the group consisting of a maleic/olefin, an olefin/acrylate, and combinations thereof having a molecular weight from about 1,000 to 20,000 g/mol; at least one amphoteric acrylic copolymer, such as an olefin/acrylate; and a detergent carrier. According to an embodiment, the soil resistant agent is a copolymer of maleic/olefin having a ratio of maleic to olefin moieties from about 0.02:1 to 5:1. According to a further embodiment, the ratio of the acrylic to the maleic moieties is from about 0.05:1 to 1:1. Preferably, the composition is substantially free of fluorinated or silicone substituents and said soil release agent is modified such that no viscosity-building or threshold activity is exhibited.

In a further embodiment of the present invention a kit is provided. The kit includes a soil resistant treatment use composition, an applicator, a removal agent for removing a plurality of soils from a treated surface, and instructions for use.

A method for treating a clean or soiled surface is further provided by the present invention. The method includes applying to a clean surface an aqueous solution of about 0.005% to 5% of a soil resistant agent selected from polymers and copolymers from the group consisting of a maleic/olefin, an olefin/acrylate, and combinations thereof, wherein said soil resistant agent has a molecular weight from about 1,000 to 20,000 g/mol, forming a laminate film of the copolymer soil resistant composition over the surface, wherein the laminate film or layer of said soil resistant composition on the clean surface has an oil/water contact angle ratio of at least 2, and removing soils from the laminate film. The method for treating a clean surface may further include diluting the soil resistant agent or composition before application to the clean surface, allowing the laminate film layer to dry and form an invisible film and/or applying a water source and/or mechanical force to remove soils.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 shows soil resistance efficiency of an exterior window after six months of treatment with a maleic/hydrophobicly modified olefin copolymer soil resistant composition (ES8804) compared to an untreated window.

FIGS. 2A-2B show photographs of treated glass slides with the maleic/hydrophobicly modified olefin copolymer soil resistant composition (ES8804) in a detergent carrier compared to a glass slide treated only with the detergent carrier solution.

FIG. 3 shows a photograph of the difference in soils on a portion of soil resistant laminate treated window versus control.

FIG. 4 shows a table measuring the surface contact angle for both corn oil and water of the treated surface and a control surface.

FIG. 5 shows cleaning efficiency results measured according to median color values according to embodiments of the invention.

### DETAILED DESCRIPTION OF THE PREFERRED EMBODIMENT

The embodiments of this invention include soil resistant laminate compositions, kits and methods of use of the same, which can vary as understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers defining the range and include each integer within the defined range.

Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities refers to variation in the numerical quantity that can occur.

As used herein, the term “hard surface” includes, but is not limited to showers, sinks, toilets, bathtubs, countertops, windows, mirrors, transportation vehicles, floors, and the like.

The term “laminate,” as used herein, refers to a substrate and at least one continuous or non-continuous coating or layer adhered to a substrate surface by a physical or chemical bond including, for example, by ionic or covalent bonding. According to an embodiment of the invention, use of a detergent carrier ensures even wetting of the surface, as opposed to conventional soil removal characteristics, resulting in the laminate formed on a treated surface.

The term “molecular weight,” as used herein with reference to the molecular weight of polymers and copolymers, refers to the calculated average molecular weight value of the polymer or copolymer, which one skilled in the art will appreciate to encompass a reasonable percent error as a result of the statistical method applied for such calculation and the variations in the polymer molecules.

The term “soil resistant agent,” as used herein, refers to a chemical agent that reduces the severity of a stain (e.g., repels staining) on a substrate surface caused by soil contact, and/or promotes easier stain removal (e.g., releases stains) from a substrate surface by decreasing the adhesion of soil on the surface through substrate surface modification or other physical or chemical mechanisms. As one skilled in the art will ascertain based upon the present disclosure of the invention, a soil resistant agent changes the soil adherence and/or release properties of a treated surface while a soil release agent changes the properties of the soil itself. The properties of soil resistant agents according to the invention are distinct from soil release agents that act on a soil rather than on the surface. This difference is most clearly illustrated by the need to apply a soil release agent with each and every cleaning of the surface, as opposed to the less frequent application of the soil resistant agents according to the invention forming a laminate surface which imparts soil resistance (i.e. repels staining).

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

According to an embodiment of the invention a novel polymeric treatment laminate composition, soil resistant treatment use composition and methods of use of the same are provided. The soil resistant laminate composition provides the unexpected advantage of providing sufficient soil resistant activity that facilitates the removal of soil by simple mechanical means, such as a water spray or air flow (e.g. compressed air) alone. Treatment of a treated surface, which may be clean or soiled prior to application, with the polymeric soil resistant treatment composition requires only the mechanical force of air or water flow for soil removal for a period of time. According to a preferred embodiment the removal of soil does not require any water source and is particularly suitable for use in climates having low water availability.

It is a further advantage of the present invention that a detergent carrier is provided for the laminate compositions and soil resistant treatment compositions according to the invention. The inclusion of a detergent carrier with the soil resistant agents according to the invention allows the treatment of either a clean and/or soiled surface with the polymers of the invention, leaving behind on the clean surface a polymer laminate coating. The formulation according to the present invention incorporating a detergent carrier ensures even wetting of the surface rather than imparting soil removal power as was conventionally achieved through the combination with a soil release agent. Following such treatment with soil resistant agent in the presence of a detergent carrier, soil does not adhere to the laminate, enabling the detergent-free subsequent cleaning of the treated surface through the use of minimal mechanical force, such as air or water flow, providing complete soil removal for an extended period of time.

The soil resistant polymeric compositions (including both the soil resistant laminate compositions and soil resistant treatment compositions) of the invention have a wide variety of uses. They can be applied to a wide variety of hard surfaces. According to the invention, the soil resistant agents (which are referred to herein synonymously as the polymers and/or copolymers of the invention) can be applied to a wide variety of hard, non-porous and/or porous surfaces, including for example: architectural surfaces, such as showers, walls, windows, countertops, appliances, tabletops, etc.; vehicle surfaces, such as cars, trucks, boats, railroad cars and planes, especially for problem areas such as windshields, rubberized trim, hulls, aluminum rails, wheels, etc.; commercial or industrial process equipment, such as “clean in place” treatments for food, beverage and other process equipment; grill cleaners, protective treatments for water handling (e.g., process water) systems; grill surfaces and the like. In some embodiments of the invention, hard surfaces may include certain porous surfaces, including for example: textiles or fabrics, floors and the like. Exemplary surfaces intended for use according to the invention include, for example, glass, concrete, porcelain, ceramic, fiberglass, plastic, rubber, metals, hard flooring surfaces, including ceramic tile, concrete and/or stone, paint, a cured polymeric coating and/or combinations thereof.

Accordingly, the soil resistant laminate compositions and soil resistant treatment compositions of the invention provides suitable compositions and methods for uses including, without limitation, glass cleaner, shower cleaner, hard surface treatment, glass treatment, transport vehicle tire and rim treatment, ware treatment and food processing area treatment. The laminate compositions of the present invention are used in combination with detergents or other cleaning agents to provide enhanced cleaning abilities and particularly imparting a soil resistant surface after initial treatment and cleaning. Such uses according to the invention can effectively replace the need for routine use of detergents and other cleaning agents to continually clean and remove soils from treated surfaces. According to certain embodiments, the soil resistant laminate compositions and soil resistant treatment compositions (including the methods of using the same) exclude the need for use of a detergent in cleaning the laminate surface after exposure to soils. In addition, creation of laminate soil resistant surfaces reduces the intensity and frequency of required cleaning activities making the treated surface easier to clean and minimizing the ongoing use of detergent compositions. In certain embodiments of the invention the present invention allows for water-free cleaning and/or low or reduced labor required for cleaning treated surfaces.

Soil Resistant Treatment Compositions

In one embodiment, the soil resistant treatment composition comprises, consists essentially of or consists of at least one soil resistant agent. According to an embodiment of the invention, the soil resistant treatment compositions change the soil repellency properties of treated surfaces to which they are applied. As used herein, a soil resistant agent refers to a chemical agent that reduces the severity of a stain (e.g., repels staining) on a substrate surface caused by soil contact, and/or promotes easier stain removal (e.g., releases stains) from a substrate surface by decreasing the adhesion of soil on the surface through substrate surface modification or other physical or chemical mechanisms.

An embodiment of the invention includes a soil resistant agent that may be a single component or a multi-component system. The compositions include at least one soil resistant agent, which are understood to refer to any combination of the various soil resistant agents disclosed herein according to the invention.

In one embodiment, the soil resistant agent is a maleic/olefin copolymer. In a further embodiment, the soil resistant agent is an olefin copolymer. In a further embodiment, the olefin is hydrophobically modified and as a result the copolymer is oleophobic to lack affinity for oils and is hydrophilic to attract water. In other embodiments, the olefin is not hydrophobically modified. In a still further embodiment, the soil resistant agent is an olefin/acrylate copolymer and/or maleic/olefin copolymer. In some embodiments, the acrylate is selected from at least one of an acrylate and/or methacrylate polymer, and/or a copolymer of acrylic acid or methacrylic acid. It is understood that the polymers and copolymers according to the invention may be modified by the addition of substituents without departing from the intent and scope of the invention. For example, in some embodiments, the polymers or copolymer do not exhibit viscosity-building or any threshold activity.

Maleic/Olefin Copolymers

Copolymers of maleic and olefin moieties may be employed as a soil resistant agent according to the invention. Particularly suitable maleic/olefin copolymers include those having a maleic/hydrophobicly-modified olefin moieties. The olefin segment may include a variety of linear, branched and cyclic alkenes. Suitable alkenes may include or be derived from propylene, isobutylene, ethylene, or butylene. Particularly suitable alkenes may include or be derived from butylene, for example, isobutylene and diisobutylene. Exemplary maleic/olefin copolymers are commercially available from BASF and include ES8804 and Sokalan CP9.

According to an embodiment of the invention, the polycarboxylate copolymer soil resistant agent comprises, consists essentially of or consists of a maleic/hydrophobicly-modified olefin copolymer. In some embodiments, the olefin is selected from at least one of an acrylate or a methacrylate. According to the invention, the copolymer is oleophobic to lack affinity for oils and hydrophilic to attract water. According to a further embodiment the maleic/hydrophobicly-modified olefin copolymer does not exhibit viscosity-building or any threshold activity. According to a preferred embodiment, the copolymer is substantially free of fluorinated or silicone substituents. According to a still further preferred embodiment the copolymer and the compositions according to the invention exclude alkali soluble resins and/or plasticizers, providing suitable compositions for floor and other surfaces coatings that exclude floor finishes. According to a further preferred embodiment the copolymer is substantially free or free of volatile organic compounds and therefore does not contribute to air pollution.

In some embodiments, the maleic/olefin copolymer of the soil resistant laminate composition has a low molecular weight, preferably less than about 20,000 g/mol, preferably less than 10,000 g/mol, more preferably less than about 7,000 and still more preferably less than about 3,000. According to another embodiment of the invention, the copolymer has a molecular weight from about 2,000 to 10,000 g/mol or from about 2,000 to 5,000 g/mol.

Exemplary maleic/olefin copolymers such as Sokalan CP9 and ES8804 are produced by BASF. According to the invention, the maleic/olefin copolymer has a maleic/olefin molar ratio from about 1:4 to 4:1, preferably from about 1:2 to 2:1, more preferably about 1:1. According to a further preferred embodiment, the olefin contains an alkyl group having more than 3 carbons, preferably more than 4 carbons. The glass transition temperature of the maleic/olefin copolymer is above the use temperature of the copolymer, preferably above 10° C.

The maleic/olefin copolymer of the soil resistant laminate composition, according to this embodiment of the invention, has a molecular weight from about 2,000 to 10,000 g/mol and a maleic/olefin ratio from about 1:4 to 4:1. More preferably, the copolymer molecular weight is from about 2,000 to 5,000 g/mol and the maleic/olefin ratio is from about 1:2 to 2:1.

According to the invention, the soil release treatment composition may preferably comprise an aqueous solution of from about 0.1% to 5% maleic/olefin copolymer, and wherein said polymer or copolymer has a molecular weight from about 1,000 to 20,000 g/mol. According to a preferred embodiment, the copolymer is substantially free of fluorinated or silicone substituents. According to a still further preferred embodiment the copolymer and the compositions according to the invention exclude alkali soluble resins and/or plasticizers, providing suitable compositions for floor and other surfaces coatings that exclude floor finishes. According to a further embodiment the maleic/olefin copolymer is modified such that no viscosity-building or threshold activity is exhibited. According to a further preferred embodiment the copolymer is substantially free or free of volatile organic compounds.

Acrylate/Olefin Copolymers

Acrylate copolymers may further be employed as a soil resistant agent according to the invention. In one embodiment, the acrylate copolymer is an acrylate/olefin copolymer. In some embodiments, the acrylate is selected from at least one of a polymer or copolymer of acrylic acid or methacrylic acid. The acrylate may further be a methacrylate. In preferred embodiments, the copolymer does not exhibit viscosity-building or any threshold activity.

The acrylate/olefin copolymers of the soil resistant treatment compositions may comprise, consist essentially of or consist of an acrylate selected from at least one of acrylate or methacrylate. According to the invention, the acrylate/olefin copolymer is oleophobic to lack affinity for oils and hydrophilic to attract water. According to a further embodiment of the invention, the acrylate/olefin copolymer does not exhibit viscosity-building or any threshold activity. According to a preferred embodiment, the acrylate/olefin copolymer is substantially free of fluorinated or silicone substituents. According to a further preferred embodiment the copolymer is substantially free or free of volatile organic compounds and therefore does not contribute to air pollution.

The acrylate/olefin copolymer of the soil resistant treatment composition, according to this embodiment of the invention, has a low molecular weight, preferably less than approximately 20,000 g/mol, preferably less than 10,000 g/mol, more preferably less than about 7,000 and still more preferably less than about 3,000. According to another embodiment of the invention, the copolymer has a molecular weight from approximately 2,000 to 10,000 g/mol or from approximately 2,000 to 5,000 g/mol, and more preferably about approximately 3,000 g/mol. The glass transition temperature of the copolymer is above the use temperature of the copolymer, preferably above 10° C.

According to the invention, the soil release treatment composition may preferably comprise an aqueous solution of from about 0.1% to 5% acrylate/olefin copolymer, and wherein said polymer or copolymer has a molecular weight from about 1,000 to 20,000 g/mol.

Additional Soil Resistant Agents and Soil Release Agents

Soil resistant agents according to the invention may be further combined and used with either additional soil resistant agents and/or in combination with soil release agents to provide improved and/or synergistic soil resistance. For example, other suitable soil resistant agents are described further in Example 10. These may also include soil resistant agents, including fluorochemical materials (e.g., Capstone ST100 and ST300 from Dupont), and polycarboxylate copolymers (e.g., Acusol 460 from Dow). However, according to certain embodiments of the invention, Acusol 460 is not desirable for use in a cured film on a solid substrate as it is a threshold agent.

Suitable soil release agents include silicone materials such as polydimethysiloxane materials (e.g., Wacker HC303 from Wacker Silicones), and acrylic polymers (Rhoplex EZ Clean 200 from Dow, Polyquart® Pro and Polyquart® Ampho 149 from Cognis Corporation).

Any combination of the foregoing agents may also be used to provide enhanced stain resistance. According to one embodiment, both the soil resistant agent and soil release agents, are substantially free of fluorinated or silicone substituents. According to a further embodiment the compositions, including both the soil resistant agent and soil release agents, are substantially free or free of volatile organic compounds. According to a still further preferred embodiment the soil resistant agents and soil release agents are not combined with nor do they contain any alkali soluble resins and/or plasticizers, providing suitable compositions for floor and other surfaces coatings that exclude floor finishes.

It has further been determined that the soil release agents Polyquart® Pro, Polyquart Ecoclean and/or Polyquart® Ampho 149, which are available from Cognis Corporation, are particularly suitable for use in combination with the soil resistant agents disclosed herein and provide soil resistant capability that is better than the stain resistance achieved when either agent is used alone. Although not intending to be limited according to a particular theory of the invention, the use of a soil release agent imparts a sticky surface for easily wiping/removing soils attracted to the surface. Despite the soil attractant effect of the soil release agents by creating a sticky surface (which when used along would require mechanical force to remove soils, use of compressed air or a water rinse is insufficient for removing soils from a surface treated with a soil release agent), the combined use with the soil resistant agents of the present invention impart a synergistic effect of soil resistance of the treated surface for an extended period of time. As a result, there is an unexpected and synergistic effect on the soil resistance and/or repellency of the treated surface. These components may have a beneficial impact on gloss as well.

Polyquart® Pro, Polyquart Ecoclean and Polyquart® Ampho 149 are amphoteric acrylic copolymers having molecular weights of at least 5,000 g/mol, more particularly, at least 10,000 g/mol. The weight ratio of a Polyquart® composition to a maleic/olefin copolymer may be, for example, from 0.02:1 to 5:1 (where all the materials are 100% active), particularly, from about 0.05:1 to 3:1, more particularly, from about 0.05:1 to 2:1.

Carriers

In some embodiments, the compositions of the present invention are formulated as aqueous use solutions. Carriers can be included in such liquid formulations. Any carrier suitable for use in the soil resistant treatment compositions can be used in the present invention. In some embodiments the compositions include a detergent carrier. The resulting composition can be homogeneous or non-homogeneous. According to a preferred embodiment of the invention, the carrier for the soil resistant treatment is a detergent, surfactant and/or rinse aid (referred to herein as a “detergent”) suitable for evenly wetting a treated surface to evenly distribute the compositions to form a laminate over treated surfaces. According to the invention, the detergent used as a carrier is not employed and/or relied upon for cleaning efficacy. Although not intending to be limited to a particular theory of the invention the detergent carrier for the compositions according to the invention may having varying amounts of detersive activity which are not required for the modification of the soil repellency of the laminate surface. Use of a surfactant detergent may promote the covering of the treated surface evenly with the laminate composition, regardless of whether the soil resistant treatment composition is applied to a soiled or cleaned surface.

In some embodiments, the soil resistant treatment compositions may be formulated as a concentrate and will contain no more than about 99 wt % detergent carrier and typically no more than about 90 wt % detergent carrier. In other embodiments, soil resistant treatment compositions will contain at least 50 wt % detergent carrier, at least 60 wt % detergent carrier, at least 70 wt % detergent carrier, or at least 80 wt % detergent carrier. These amounts include all amounts of detergent carrier in between the ranges as one of skill in the art shall ascertain.

In some embodiments, the soil resistant treatment compositions are used as a use solution and will contain from about 0.01-10 wt % detergent carrier and typically no more than about 5 wt % detergent carrier. In other embodiments, soil resistant treatment use solutions compositions will contain at least 0.1-2 wt % detergent carrier. A use solution according to the invention will contain from about 0.01-20 wt % soil resistant polymer or at a level equal to or greater than the detergent carrier concentration. These amounts include all amounts of detergent carrier in between the ranges as one of skill in the art shall ascertain.

According to an alternative embodiment of the invention, one of skill in the art can obtain other, non-aqueous forms of the compositions of the invention. These can include for example, solids, liquids including emulsions or dispersions, gels, and pastes. Such embodiments can be a single part or multi part package.

Use of a detergent or cleaning agent carrier is not intended to provide added stain resistant capability to the laminate composition. Use of a detergent or cleaning agent as a carrier for the compositions of the invention allows for application to a clean and/or soiled surface. According to such an embodiment, the soil resistant agent is applied to a surface in a use composition with a detergent carrier to ensure even application of the polymers to a surface. Upon drying of the laminate with the soil resistant agent of the invention and the detergent, according to the invention, excess detergent which would be expected to impart cleaning efficacy from the detergent is not desirable. Excess use of detergent as a carrier will result in the detergent remaining on the surface and is unexpectedly problematic for soil resistance performance according to the invention. As a result, detergent carrier concentration is minimized to allow the beneficial effects of even application of the polymers to a treated surface or, at the least, the composition of the detergent carrier is selected to ensure it does not modify the water and oil contact angles imparted to the surface when the polymer dries on it.

According to such an embodiment of the invention, the carrier can be composed of any components used to form a detergent. For example, the cleaning agent carrier may be formed of amines, fatty acid, caustics, alkaline sources, salts, solvents or surfactants. In one embodiment, the cleaning agent is a fatty acid salt or a combination of a fatty acid and an alkalinity source. In particular, the cleaning agent may be formed of a fatty acid amine salt. For example, the cleaning agent may be a mixture of oleic acid and monoethanolamine (MEA). The term “fatty acid” includes any of a group of carboxylic acids that can be derived from or contained in an animal or vegetable fat or oil. Fatty acids are composed of a chain of alkyl groups and characterized by a terminal carboxyl group. The alkyl groups can be linear or branched. The fatty acid can be saturated or unsaturated. In some embodiments, the chain of alkyl groups contain from 4 to 24 carbon atoms, particularly from 6 to 24 carbon atoms, and more particularly from 12 to 18 carbon atoms. The detergent composition can include combinations or mixtures of different fatty acids. An example of a suitable fatty acid is oleic acid, but as set forth above, a broad variety of other fatty acids or combinations or mixtures thereof are contemplated for use.

The fatty acid component can include up to about 50% by weight of the detergent composition concentrate, with the remainder comprising water. For example, the detergent composition can include, in the range of 2% to about 50% by weight fatty acid component, in some embodiments in the range of about 5% to about 35% by weight fatty acid component, and in some embodiments in the range of about 5% to about 20% by weight fatty acid component. Some examples of dilute or use detergent compositions can include, in the range of 0.005 to about 10% by weight fatty acid component, in some embodiments in the range of about 0.008% to about 2.5% by weight fatty acid component, and in some embodiments in the range of about 0.015% to about 1% by weight fatty acid component. Examples of suitable fatty acid-containing detergent compositions include StoneMedic DCC, NeoMat Forte and NeoMat S, which are aqueous soap based cleaners all available from Ecolab, Inc.

Amines are organic derivatives of ammonia in which one or more of the ammonia hydrogens are replaced by alkyl or aromatic groups. A variety of organic amines may be employed in the compositions and methods of the present invention. Representative organic amines are alkyl amines, which may be primary, secondary, or tertiary, such as isopropylamine, ethylmethylamine and trimethylamine, or substituted organoamines (e.g., alkanolamines) such as monoethanolamine, diethanolamine and triethanolamine, 1,2-diaminoethane, 1,2-diaminopropane, N-benzylethanolamine, 2-aminomethylpropanol, furfurylamine, tetrahydrofurfurylamine and the like, and mixtures thereof, or cyclic amines such as morpholine, or ethoxylate amines such as ethoxylated tallow amine, ethoxylated coconut amine, ethoxylated alkyl propylene amines, and the like, and mixtures thereof. In particular, the amine may be an organoamine which may be accompanied by other amines or by salts of the amines.

When the detergent composition is formulated as a concentrate, the organic amine may represent, for example, between about up to about 50%, between about 5% and about 35% or about 5% and about 20% of the total concentrate weight. The amount of amine in the detergent composition may also be expressed in terms of the molar equivalent ratio of acid to amine. For example, acid:amine molar equivalent ratios of between about 0.5:1 and about 2:1 may be employed. However, the amount of amine may be adjusted to obtain a desired pH in the final concentrate or use-solution.

When a fatty acid is used as the cleaning agent in the detergent composition, the detergent composition can include an effective amount of one or more caustic sources to enhance cleaning of a substrate and improve soil removal performance of the detergent composition. In general, it is expected that the composition may include the caustic source in an amount of at least about 0.1% by weight, at least about 5% by weight, or at least about 10% by weight.

Examples of suitable caustic sources of the detergent composition include, but are not limited to an alkali metal carbonate and an alkali metal hydroxide. Exemplary alkali metal carbonates that can be used include, but are not limited to: sodium or potassium carbonate, bicarbonate, sesquicarbonate, and mixtures thereof. Exemplary alkali metal hydroxides that can be used include, but are not limited to sodium, or potassium hydroxide. The alkali metal hydroxide may be added to the composition in any form known in the art, including as solid beads, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 50% and a 73% by weight solution. It is preferred that the alkali metal hydroxide is added in the form of an aqueous solution, particularly a 50% by weight hydroxide solution, to reduce the amount of heat generated in the composition due to hydration of the solid alkali material.

In addition to the first caustic source, the detergent composition may comprise a secondary caustic source. Examples of useful secondary caustic sources include, but are not limited to: metal silicates such as sodium or potassium silicate or metasilicate; metal carbonates such as sodium or potassium carbonate, bicarbonate, sesquicarbonate; metal borates such as sodium or potassium borate; and ethanolamines and amines. Such caustic agents are commonly available in either aqueous or powdered form, either of which is useful in formulating the present solid detergent compositions.

The cleaning agent for use as detergent carrier according to the invention is present in an amount effective to provide detersive properties on the treated soiled or cleaned surface. An effective amount should be considered as an amount that provides a use composition having a pH of between about 7 and about 11, particularly between about 7 and 10, and more particularly between about 7 and about 9.5. Additional pH adjusting agents may be used to provide the use composition with the desired pH. Suitable pH adjusting agents for such alkaline-based compositions include organic and inorganic acids, such as acetic acid, hydrochloric acid, sulfuric acid and citric acid.

One skilled in the art shall ascertain the amounts of particular cleaning agents that may be formulated for use with the soil resistant agent according to the invention. For example, formulations including a detergent composition may be formulated in various formulations, including for example concentrates or ready-to-use formulations. In addition, formulations may be adjusted to obtain desired pH, concentration, and other conditions that may vary according to the desired use of the soil resistant composition according to the invention.

Additional Functional Agents

The compositions may also include additional functional materials. In addition to use of cleaning agents as a detergent carrier for the compositions of the present invention, additional functional ingredients may be incorporated dependent upon the particular surface in need of treatment. For example, additional functional ingredients, and suitable amounts and formulations thereof, for use on porous and non-porous floor surfaces are disclosed in U.S. patent application Ser. Nos. ______ (Attorney Docket Numbers 2815USU1 and 2816USU1), herein incorporated by reference in its entirety. Exemplary suitable functional ingredients may include, for example, solvents, fragrances, anti-slip agents, gloss agents, including gloss enhancing additives, detergents, etc.

For example, according to an embodiment of the invention, a gloss agent, such as a gloss enhancing additive is included in the composition formulations of the invention. According to an additional embodiment of the invention, one or more additives suitable for use in a floor finish application are excluded. According to an exemplary embodiment, an alkali soluble resin, polyethylene, polypropylene and/or surfactant additive are excluded. According to a still further embodiment, the compositions according to the invention remain clear at all times (as opposed to floor finishes which are opaque milky emulsions).

For the purpose of this application, the term “functional materials” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and a broad variety of other functional materials may be used. For example, many of the functional materials discussed below relate to materials used in cleaning applications. However, other embodiments may include functional materials for use in other applications.

Solvents

Certain solvents are suitable for use according to the invention. Solvents may be included as a carrier and/or for even spreading of the compositions across a surface. Exemplary organic solvents that can be used include hydrocarbon or halogenated hydrocarbon moieties of the alkyl or cycloalkyl type, and have a boiling point well above room temperature, i.e., above about 30° C.

Considerations for selecting organic solvents include beneficial properties and aesthetic considerations. For example, in some applications where malodors would not be tolerated, the formulator would be more likely to select solvents which have a relatively pleasant odor, or odors which can be reasonably modified by perfuming.

The C6-C9 alkyl aromatic solvents, especially the C6-C9 alkyl benzenes, preferably octyl benzene, exhibit excellent grease removal properties and have a low, pleasant odor. Likewise the olefin solvents having a boiling point of at least about 100° C., especially alpha-olefins, preferably 1-decene or 1-dodecene, are excellent grease removal solvents.

Generically, the glycol ethers can be used. Exemplary glycol ethers include monopropyleneglycolmonopropyl ether, dipropyleneglycolmonobutyl ether, monopropyleneglycolmonobutyl ether, ethyleneglycolmonohexyl ether, ethyleneglycolmonobutyl ether, diethyleneglycolmonohexyl ether, monoethyleneglycolmonopropyl ether-, diethyleneglycolmonobutyl ether, and mixtures thereof.

Solvents such as pine oil, orange terpene, benzyl alcohol, n-hexanol, phthalic acid esters of C1-4 alcohols, butoxy propanol, Butyl Carbitol® and 1(2-n-butoxy-1-methylethoxy)propane-2-ol (also called butoxy propoxy propanol or dipropylene glycol monobutyl ether), hexyl diglycol (Hexyl Carbitol®), butyl triglycol, isopropyl alcohol, diols such as 2,2,4-trimethyl-1,3-pentanediol, and mixtures thereof, can also be used.

The concentrate can include the organic solvent component in an amount to provide the desired cleaning, product stability and evaporative properties. In general, the amount of solvent should be limited so that the use solution is in compliance with volatile organic compound (VOC) regulations for a particular class of cleaner. In addition, it should be understood that the organic solvent is an optional component and need not be incorporated into the concentrate or the use solution according to the invention. When the organic solvent is included in the concentrate, it can be provided in an amount of between about 0.1 wt % and about 75 wt %, between about 1 wt % and about 50 wt %, and between about 3 wt % and about 30 wt %.

Surfactants

The composition can include a surfactant or surfactant mixture. A variety of surfactants can be used in a composition according to the invention having a detergent carrier, including, but not limited to: anionic, nonionic, cationic, and amphoteric (including zwitterionic) surfactants. Surfactants are an optional component of the detergent composition and can be excluded from the concentrate. Exemplary surfactants that can be used are commercially available from a number of sources. For a discussion of surfactants, see Kirk Othmer, Encyclopedia of Chemical Technology, Third Edition, volume 8, pages 900 912, incorporated herein by reference in its entirety. When the detergent composition includes a surfactant or a mixture of surfactants, the surfactant is provided in an amount effective to provide a desired level of functionality, such as wetting, stability, foam profile and cleaning. The detergent composition, when provided as a concentrate, can include the surfactant in a range of about 0.05% to about 50% by weight, about 0.5% to about 40% by weight, about 1% to about 30% by weight, about 1.5% to about 20% by weight, and about 2% to about 15% by weight. Additional exemplary ranges of surfactant in a concentrate include about 0.5% to about 10% by weight, and about 1% to about 8% by weight.

Examples of anionic surfactants useful in the detergent composition include, but are not limited to: carboxylates such as alkylcarboxylates and polyalkoxycarboxylates, alcohol ethoxylate carboxylates, nonylphenol ethoxylate carboxylates; sulfonates such as alkylsulfonates, alkylbenzenesulfonates, alkylarylsulfonates, alpha olefinsulfonate, sulfonated fatty acid esters; sulfates such as sulfated alcohols including fatty alcohol sulfates, sulfated alcohol ethoxylates, sulfated alkylphenols, alkylsulfates, sulfosuccinates, and alkylether sulfates.

Examples of nonionic surfactants useful in the detergent composition include, but are not limited to, those having a polyalkylene oxide polymer as a portion of the surfactant molecule. Such nonionic surfactants include, but are not limited to: chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated amines such as alkoxylated ethylene diamine; alcohol alkoxylates such as alcohol ethoxylate propoxylates, alcohol propoxylates, alcohol propoxylate ethoxylate propoxylates, alcohol ethoxylate butoxylates; nonylphenol ethoxylate, polyoxyethylene glycol ether; carboxylic acid esters such as glycerol esters, polyoxyethylene esters, ethoxylated and glycol esters of fatty acids; carboxylic amides such as diethanolamine condensates, monoalkanolamine condensates, polyoxyethylene fatty acid amides; and polyalkylene oxide block copolymers. An example of a commercially available ethylene oxide/propylene oxide block copolymer includes, but is not limited to, PLURONIC®, available from BASF Corporation, Florham Park, N.J. An example of a commercially available silicone surfactant includes, but is not limited to, ABIL® B8852, available from Goldschmidt Chemical Corporation, Hopewell, Va.

Examples of cationic surfactants that can be used in the detergent composition include, but are not limited to: the acid salts of amines such as primary, secondary and tertiary monoamines with C1-8 alkyl or alkenyl chains, ethoxylated alkylamines, alkoxylates of ethylenediamine, imidazoles such as a 1-(2-hydroxyethyl)-2-imidazoline, a 2 alkyl-142-hydroxyethyl)-2-imidazoline, and the like; and quaternary ammonium salts, as for example, alkylquaternary ammonium chloride surfactants such as n alkyl(C12 C18)dimethylbenzyl ammonium chloride, n tetradecyldimethylbenzylammonium chloride monohydrate, and a naphthylene-substituted quaternary ammonium chloride such as dimethyl-1-naphthylmethylammonium chloride. The cationic surfactant can be used to provide sanitizing properties.

Some surfactants can also function as secondary solidifying agents if a solid detergent composition is desired. For example, anionic surfactants which have high melting points provide a solid at the temperature of application. Anionic surfactants which have been found most useful include, but are not limited to: linear alkyl benzene sulfonate surfactants, alcohol sulfates, alcohol ether sulfates, and alpha olefin sulfonates. Generally, linear alkyl benzene sulfonates are preferred for reasons of cost and efficiency.

Amphoteric or zwitterionic surfactants are also useful in providing detergency, emulsification, wetting and conditioning properties. Representative amphoteric surfactants include, but are not limited to: N-coco-3-aminopropionic acid and acid salts, N-tallow-3-iminodiproprionate salts, N-lauryl-3-iminodiproprionate disodium salt, N-carboxymethyl-N-cocoalkyl-N-dimethylammonium hydroxide, N-carboxymethyl-N-dimethyl-N-(9-octadecenyl)ammonium hydroxide, (1-carboxyheptadecyl) trimethylammonium hydroxide, (1-carboxyundecyl) trimethylammonium hydroxide, N-cocoamidoethyl-N-hydroxyethylglycine sodium salt, N-hydroxyethyl-N-stearamidoglycine sodium salt, N-hydroxyethyl-N-lauramido-.beta.-alanine sodium salt, N-cocoamido-N-hydroxyethyl-.beta.-alanine sodium salt, mixed alicyclic amines and their ethoxylated and sulfated sodium salts, 2-alkyl-1-carboxymethyl-1-hydroxyethyl-2-imidazolinium hydroxide sodium salt or free acid wherein the alkyl group may be nonyl, undecyl, and heptadecyl.

Other useful amphoteric surfactants include, but are not limited to: 1,1-bis(carboxymethyl)-2-undecyl-2-imidazolinium hydroxide disodium salt and oleic acid-ethylenediamine condensate, propoxylated and sulfated sodium salt, and amine oxide amphoteric surfactants. Additional examples of amphoteric surfactants that can be used in the detergent composition include, but are not limited to: betaines such as dodecyl dimethyl sulfobetaine, imidazolines, and propionates.

Polymers

Optionally polymer additives can be used in the detergent composition to provide desirable benefits. Examples of the benefits include that some polymers can function as solidifying agents if a solid detergent composition is desired. Some polymers can function as a solution rheology modifier, some polymers can function as a chelating agent, some polymers can function as a stabilizer and some polymers can provide multi-benefits to the detergent composition.

Exemplary polymer rheology modifiers include Acusol 810A and Acusol 842, both are alkali soluble acrylic polymer emulsions available from Dow Chemical. These materials also function as stabilizers. Other examples of polymeric stabilizers include ACUSOL 820, a hydrophobically modified alkali soluble acrylic polymer emulsion (HASE) and polyols such as ACUSOL™ 880, a hydrophobically modified, nonionic polyol. Both are available from Dow Chemical. Exemplary polymeric chelating agent include acrylic polymers and their copolymers, such as ACUSOL™ 497N, a copolymer of acrylic acid and maleic anhydride available from Dow Chemical.

Fragrances

Various odorants including perfumes, and other aesthetic enhancing agents can also be included in the composition. Fragrances or perfumes that may be included in the compositions include, but are not limited to: terpenoids such as citronellol, aldehydes such as amyl cinnamaldehyde, a jasmine such as C1S-jasmine or jasmal, and vanillin.

Other Functional Materials

In addition to the functional materials mentioned above, other optional additional functional materials that can be included in the soil resistant treatment compositions using a detergent carrier, as disclosed according to the present invention. For example, these include chelating agents such as ethylene diamine tetraacetic acid (EDTA) and its sodium salts; pH adjusters such as amines, acids and pH buffers; foam modifiers such as defoamers.

The soil resistant treatment compositions, along with its formulation to include a variety of other functional materials, according to the invention and the laminate formed by application of the soil resistant treatment compositions are stable over a relatively wide range of pH values, e.g., between about 3 and about 14.

Soil Resistant Laminate Compositions

A further embodiment of the invention includes a soil resistant laminate composition. The composition comprises, consists essentially of or consists of a multilayer composition comprising a clean or soiled surface as a bottom layer and a dried layer of the soil resistant treatment composition.

According to a first embodiment of the invention, the soil resistant laminate composition includes a clean or soiled surface as a bottom layer and a dried layer of a polycarboxylate copolymer of maleic/olefin soil resistant agent provided in a detergent carrier. According to a further embodiment of the invention, the polycarboxylate copolymer of the soil resistant laminate composition comprises, consists essentially of or consists of a maleic/hydrophobicly-modified olefin copolymer. According to the invention, the copolymer is oleophobic to lack affinity for oils and hydrophilic to attract water, does not exhibit viscosity-building or any threshold activity, is substantially free of fluorinated or silicone substituents, and/or is substantially free or free of volatile organic compounds.

In some embodiments, a soil resistant laminate composition having a maleic/olefin copolymer as the soil resistant agent has a low molecular weight, preferably less than about 20,000 g/mol, preferably less than 10,000 g/mol, more preferably less than about 7,000 and still more preferably less than about 3,000. According to another embodiment of the invention, the copolymer has a molecular weight from about 2,000 to 10,000 g/mol or from about 2,000 to 5,000 g/mol. According to another embodiment, the maleic/olefin copolymer has a maleic/olefin molar ratio from about 1:4 to 4:1, preferably from about 1:2 to 2:1, more preferably about 1:1. Exemplary maleic/olefin copolymers such as Sokalan CP9 and ES8804 are produced by BASF.

According to a second embodiment of the invention, the soil resistant laminate composition includes a clean or soiled surface as a bottom layer and a dried layer of an olefin/acrylate copolymer soil resistant agent provided in a detergent carrier. According to a further embodiment of the invention, the olefin/acrylate copolymer of the soil resistant laminate composition according to the invention comprises, consists essentially of or consists of an acrylate-type moiety selected from at least one of an acrylate or a methacrylate. According to the invention, the acrylate/olefin copolymer is oleophobic to lack affinity for oils and hydrophilic to attract water. According to a further embodiment of the invention, the copolymer does not exhibit viscosity-building or any threshold activity. According to a preferred embodiment, the copolymer is substantially free of fluorinated or silicone substituents. According to a further preferred embodiment the copolymer is substantially free or free of volatile organic compounds and therefore does not contribute to air pollution.

In some aspects of the invention, a soil resistant laminate composition having a olefin/acrylate copolymer as the soil resistant agent has a low molecular weight, preferably less than about 20,000 g/mol, preferably less than 10,000 g/mol, more preferably less than about 7,000 and still more preferably less than about 3,000. According to another embodiment of the invention, the acrylate/olefin copolymer has a molecular weight from about 2,000 to 10,000 g/mol or from about 2,000 to 5,000 g/mol. According to a further embodiment, the acrylate/olefin contains an alkyl group having more than 3 carbons, preferably more than 4 carbons. The glass transition temperature of the olefin copolymer is above the use temperature of the copolymer, preferably above 10° C. Exemplary olefin polymers include ES8804 which is produced by BASF Corporation. According to a third embodiment of the invention, the soil resistant laminate composition includes a clean or soiled surface as a bottom layer and a dried layer of an acrylate polymer or copolymer soil resistant agent provided in a detergent carrier. The acrylate polymer or copolymer of the soil resistant laminate composition according to the invention comprises, consists essentially of or consists of an acrylate selected from at least one of an acrylic acid or a methacrylic acid polymer or copolymer. According to the invention, the acrylate is oleophobic to lack affinity for oils and hydrophilic to attract water. According to a further embodiment of the invention, the acrylate does not exhibit viscosity-building or any threshold activity. According to a preferred embodiment, the acrylate polymer or copolymer is substantially free of fluorinated or silicone substituents. According to a further preferred embodiment the copolymer is substantially free or free of volatile organic compounds and therefore does not contribute to air pollution.

In some embodiments, a soil resistant laminate composition having an acrylate polymer or copolymer as the soil resistant agent has a low molecular weight, preferably less than approximately 20,000 g/mol, preferably less than 10,000 g/mol, more preferably less than about 7,000 and still more preferably less than about 3,000. According to another embodiment of the invention, the polymer or copolymer has a molecular weight from approximately 2,000 to 10,000 g/mol or from approximately 2,000 to 5,000 g/mol and is selected from the group consisting of acrylic acid, methacrylic acid polymers and copolymers and combinations thereof. Exemplary acrylate polymers include Acusol 460 and are produced by Acusol 929.

According to a still further embodiment of the invention, the soil resistant laminate composition includes a clean surface as a bottom layer and a dried layer of more than one soil resistant agents selected from the group consisting of a polycarboxylate copolymer of maleic/olefin soil resistant agent, an olefin polymer or copolymer soil resistant agent, an acrylate polymer or copolymer soil resistant agent, and combinations thereof, which are provided in a detergent carrier. Any combinations of the soil resistant agents disclosed herein may be used for the formulations of any soil resistant treatment composition and/or soil resistant laminate composition according to the invention.

According to the various embodiments of the invention, the suitable copolymers and the compositions according to the invention may exclude alkali soluble resins and/or plasticizers, providing suitable compositions for floor and other surfaces coatings that exclude floor finishes.

The soil resistant laminate compositions according to the invention comprising, consisting essentially of or consisting of a multilayer composition having an oil/water contact angle ratio of the laminate surface of at least 2, comprising a clean or soiled surface as a bottom layer and a dried layer of the soil resistant treatment composition comprising at least one soil resistant agent as a top layer, wherein said dried layer is formed from an aqueous solution of from about 0.005% to about 20%, preferably from about 0.1% to about 5% soil resistant agent in an aqueous use solution of a soil resistant agent having a lower molecular weight from about 1,000 to about 20,000 g/mol. According to a preferred embodiment, the soil resistant agents (and soil resistant treatment compositions) are substantially free of fluorinated or silicone substituents, are modified such that no viscosity-building or threshold activity is exhibited, and/or are substantially free or free of volatile organic compounds.

According to an embodiment of the invention, the soil resistant treatment compositions modify or change the water and oil contact angles exhibited by a treated surface, whether clean or soiled. The soil resistant treatment compositions prevent the adhesion of soils to the treated surface while promoting displacement behavior to create a self-cleaning surface. In some instances it may be desirable to increase one or both of the water contact angle or oil contact angle. For example, the water contact angle can be significantly reduced or the oil contact angle can be significantly increased, in order to increase the ratio of oil contact angle to water contact angle. Also, it will be preferred to select the nature and type of treatment based on the ratio of oil contact angle to water contact angle for the treated surface. Preferably the ratio of oil contact angle to water contact angle for the laminate surface resulting from the soil resistant treatment compositions on the clean surface according to the invention is at least 2. More preferably, the ratio of oil contact angle to water contact angle of the laminate surface according to the invention is at least 4. Most preferably, the ratio of oil contact angle to water contact angle of the laminate surface according to the invention is at least 6.

The ratio of oil contact angle to water contact angle of the laminate surface according to the invention of at least 2, preferably at least 4 and most preferably at least 6 provides enhanced soil resistance of both inorganic and oily soils from the treated clean substrate. When the ratio of oil contact angle to water contact angle is sufficiently high, water tends to form a sheet on the treated surface, oil tends to form beads on the treated surface, and the water sheet tends to wedge underneath the soil and lift away the oil beads from the treated surface. This phenomenon can be observed by placing a water droplet and oil droplet side-by-side on the treated surface and observing the behavior of the droplets under magnification when they contact one another.

A further embodiment of the invention includes a laminate composition comprising, consisting essentially of or consisting of a porous or non-porous surface, such as a floor surface, and at least one continuous or non-continuous coating or layer adhered to the treated surface by a physical or chemical bond including, for example, by ionic or covalent bonding.

According to the invention, the dry-to-touch laminate surface formed by the soil resistant treatment compositions of the invention, in combination with the oil/water contact angle ratio of at least 2 provide enhanced soil resistance. Not intending to be limited by a particular theory, it is believed that the combination of the at least two soil resistance mechanisms of action provide enhanced soil resistance. The soil resistance mechanisms are distinct from those of soil release agents, as a laminate resistant surface is formed rather than a tacky film or surface, which would causes a clean surface to become soiled more quickly, as would result from commercially-available soil release agents being applied to a clean surface.

The laminate surface formed by the soil resistant treatment compositions of the invention can be further enhanced by the addition of a soil release agent. Particularly suitable soil release agents for use in combination with the soil resistant agents according to the invention include an amphoteric acrylic copolymer soil release agent. Exemplary acrylic copolymer includes Polyquart® Pro and/or Polyquart® Ampho 149, which are available from Cognis Corporation and may be hydrophobically modified according to embodiments of the invention.

Methods of Use

An embodiment of the invention includes a method for treating a surface, which may be a clean surface, a substantially clean surface and/or a soiled surface, comprising, consisting essentially of or consisting of applying to the surface a soil resistant treatment composition according to the invention and forming a laminate film of the soil resistant treatment composition over the surface. An additional method step of removing soils from the top surface of the formed laminate film may further be included according to the invention.

According to additional embodiments of the invention, the soil resistant treatment composition can be applied to a wide variety of hard, porous and/or nonporous surfaces. Exemplary hard surfaces include: architectural surfaces, such as showers, walls, windows, countertops, appliances, tabletops, etc.; vehicle surfaces, such as cars, trucks, boats, railroad cars and planes, especially for problem areas such as windshields, rubberized trim, hulls, aluminum rails, wheels, etc.; commercial or industrial process equipment, such as “clean in place” treatments for food, beverage and other process equipment; grill cleaners, protective treatments for water handling (e.g., process water) systems; grill surfaces and the like.

In some embodiments of the invention, hard surfaces may include certain porous surfaces, including for example: textiles or fabrics, floors and the like. For example, porous surfaces may include floors, such as those disclosed in U.S. patent application Ser. Nos. ______ (Attorney Docket Numbers 2815USU1 and 2816USU1), herein incorporated by reference in its entirety. Floors may include uncoated floors (e.g. not coated with floor finishes), including for example, polished and unpolished marble, polished and unpolished concrete, terrazzo and ceramic tile. Additional floor surfaces may include, whether porous or non-porous, marble, granite, terrazzo, concrete, dry shake, ceramic tiles, wood, linoleum, vinyl, cork, bamboo and rubber substrates.

Exemplary hard surfaces, whether porous or nonporous, intended for use according to the invention include, for example, glass, porcelain, ceramic, wood, fiberglass, plastic, rubber, metals, hard flooring surfaces, including vinyl, vinyl composite, wood, ceramic tile, concrete and/or stone, paint a polymer or combinations thereof.

According to a further embodiment, the method comprises, consists essentially of or consists of applying to either a clean and/or soiled surface an aqueous solution of about 0.005% to about 20%, preferably from about 0.1% to about 5% soil resistant agent in an aqueous use solution of a soil resistant agent having a low molecular weight from about 1,000 to about 20,000 g/mol. and forming a laminate film of the soil resistant treatment composition over the surface, and/or drying the composition to form a coating of the soil resistant treatment composition over the treated surface. The treated surface can then be cleaned to remove soils from the laminate film. The methods of the invention may further include the use of a soil release agent and/or additional soil resistant agent for synergistic improvements in cleaning efficiency of the treated surface. According to an embodiment of the invention, an aqueous solution may further comprise about 0.005% to about 20%, preferably from about 0.1% to about 5% soil release agent.

Although not intended to be limited according to a particular theory, the forming of a laminate film on a surface results in a physical coating (e.g. a mechanical adhesion) rather than a chemical bond (e.g. a covalent bond) to the substrate surface. Methods according to the invention may further include combing the copolymer with a detergent composition in order to clean a surface suitable for treatment with the soil resistant copolymer composition and leaving a residue, such as a laminate film of the copolymer soil resistant, on the clean surface. According to a further embodiment, the soil resistant copolymer is not used in combination with cationic surfactants.

According to a further embodiment, the polymer layer of the soil resistant laminate is not discernible by visual inspection. According to a still further embodiment, the polymer layer does not constitute a floor finish.

According to the invention, subsequent cleaning of the treated surface results in easier cleaning (i.e. enhanced cleaning efficiency) due to soil being lightly adhered to the surface rather than bonded to the surface. As a result, the surface may be subsequently cleaned with a gentle source of water (i.e. hose or naturally as a result of rain), or cleaned without the use of water, such as with mechanical action, compressed air, etc. For example, according to one embodiment of the invention a treated surface such as vehicle may be cleaned with a source of compressed air (i.e. air curtain) rather than requiring a water source. This would be particularly beneficial in drought-stricken areas where water is at a premium.

The soil resistant copolymer treatment composition according to the invention may be applied to a clean and/or soiled surface. A surface to be treated according to the invention may be cleaned using cleaning agents or solvents that will be familiar to those skilled in the art. As disclosed herein, such a detergent (cleaning agent) may be preferably incorporated into the soil resistant treatment composition according to the invention. Application of the soil resistant treatment composition may include the step of spraying or evenly spreading the composition over the surface and wiping off (e.g. removing by mechanical force such as a sponge or other receptacle) any excess composition. The method may further include allowing the laminate film layer to dry and form an invisible film after applying to said surface. According to an embodiment of the invention, the soil resistant treatment composition is allowed to remain on the surface for sufficient period of time to enable formation of a dry-to-touch laminate film. According to an embodiment of the invention, the soil resistant treatment composition forms a dry-to-touch laminate film within about an hour, preferably within about 30 minutes, more preferably within less than five minutes and still more preferably within less than one minute.

The laminate film formed over the surface by the soil resistant agent is an invisible film. Preferably the laminate film is water resistant, more preferably the film is water resistant and not water insoluble. The dry-to-touch laminate film formed by the soil resistant treatment composition is layered or coats the clean surface and exhibits soil resistant properties minimizing and/or preventing bonding of soils to the surface.

In addition, the step of removing soils from the laminate film may further include applying a water source, a cleaning agent and/or mechanical force to remove soils. For example, the use of non-traditional mechanical force, such as compressed air or a vacuum can be utilized to clean the soil-resisting laminate film. In an embodiment of the invention, soil on the laminate is removed using compressed air, alone or combined with water. The laminate film can be cleaned accordingly without the need to reapply the soil resistant copolymer composition, for example, for several weeks and even months. When desirable, additional soil resistant treatment composition may be applied to a surface in need of treatment (whether clean or soiled) to provide ongoing soil resistance.

Preferably, the step of removing soils from the laminate film does not require further use of a detergent composition for the removal of soils and/or cleaning of the treated surface to maintain soil resistance of the surface as a result of the formulation of the soil resistant agent in a detergent carrier. However, soil can be removed with a cleaning agent if desired.

As a result, the soil resistant laminate can be cleaned with water, without causing removal of the soil resistant laminate, for extended periods of time. The laminate film can be cleaned, for example with a deliberate flow of water, such as from a hose or a natural source such as rain for external surfaces, without the need to reapply the soil resistant copolymer composition, for example, for several weeks and even months. When desirable, additional soil resistant copolymer composition may be applied to a cleaned surface to provide ongoing soil resistance.

If desired, the soil resistant copolymer laminate layer can be removed by those skilled in the art by a variety of techniques that can be employed to bring about such removal. One convenient method is by spraying or soaking the treated surface with a removal solution.

Kits

According to a further embodiment of the invention, the soil resistant treatment composition of the invention can be packaged and provided as kits for soil resistant surface treatments. According to an embodiment of the invention, a kit may comprise, consist of and/or consist essentially of the soil resistant agent according to the invention (formulated into the soil resistant treatment composition), an applicator, and suitable instructions for use. According to additional embodiments of the invention the kit may also optionally include a removal agent for removing a plurality of soils from a treated surface a removal agent for removing a plurality of soils from a treated surface. In one embodiment, the kit includes the soil resistant composition and a separate cleaning agent that may be optionally combined with the soil resistant composition prior to use.

An applicator for a kit according to the invention may include a variety of means of application. For example, as one skilled in the art may ascertain, applicator may include a mechanism to spray a liquid, including for example a misting applicator, a mop, a dispenser, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

### Exterior Window Treatment

Soil resistant window compositions were prepared according to the invention using various dilutions of the soil resistant copolymer composition of the invention (commercially available from BASF). The tested maleic/hydrophobicly modified olefin copolymer had 25% solids and a molecular weight of about 3000. The copolymer was sprayed onto an exterior window and then wiped dried with paper towels to remove excess liquid. The soil resistant copolymer composition was compared to a control window sprayed with a commercial glass cleaner (Glass Force®, Ecolab) which was also applied to a window and then wiped dry with paper towels to remove excess liquid.

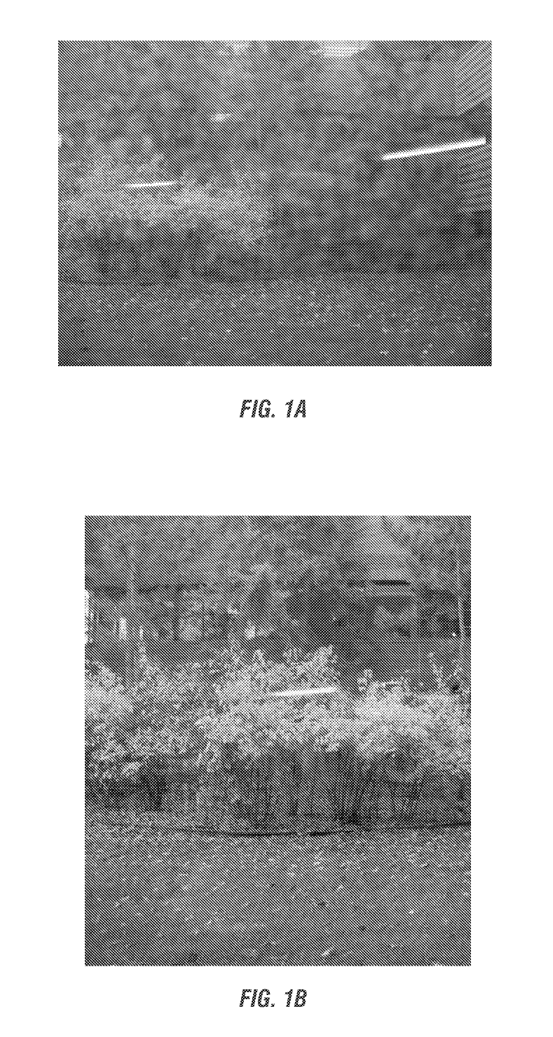

The windows were exposed to the elements without any cleaning for 6 months. The windows were equally subjected to rain, roof run-off, blowing dust, and an in-ground irrigation system using 17 grain hardness well water. The windows treated with the maleic/hydrophobicly modified olefin copolymer according to the invention (both 5% and 1%) remained significantly-free of soils after the 6 month period. FIG. 1A shows the control window was significantly soiled and required cleaning to remove visible soils from surface after six months. FIG. 1B shows the window treated with 5% soil resistant copolymer composition did not yet require cleaning. The maleic/hydrophobicly modified olefin copolymer provided soil resistance to the treated windows as demonstrated by the windows being substantially cleaner at the end of the test period than the control.

The soil-resistant action further demonstrates unexpected longevity. Treated windows have remained with demonstrated soil resistance for up to at least three years. Although not intended to be limited according to a particular theory, the soil resistant agent forms a laminate layer over the treated surface and provides the soil resisting properties that effectively prevent soils from bonding to the surface and may be further combined with a detergent carrier according to an embodiment of the invention.

### Example 2

### Removal of Soil Using Compressed Air from a Soil Resistant Glass Laminate

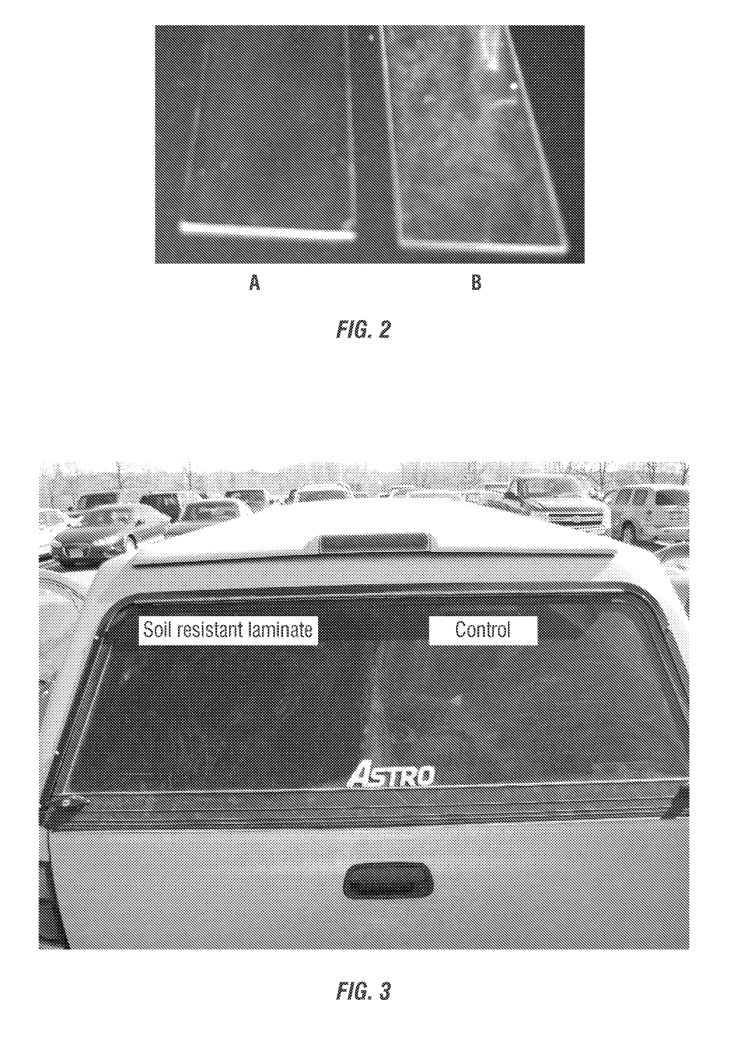

A glass slide was treated with 2.5% solution of the maleic/hydrophobicly modified olefin copolymer in a detergent carrier (Glass Force®, Ecolab) to form a soil resistant laminate (FIG. 2A). A second glass slide was cleaned with the unmodified formula (Glass Force®, Ecolab) (FIG. 2B). Clay was used to soil the entire surface of the slides and compressed air alone was then used to blow non-adhering clay on each of the surfaces.

The glass slide with the soil resistant laminate provided substantial cleaning with the air flow alone, whereas the glass slide without the soil resistant laminate did not demonstrate removal of remaining soil with air flow alone. The experiment demonstrates the ability to use indirect mechanical action (excluding water) to clean a surface treated with the soil resistant maleic/hydrophobicly modified olefin copolymer according to the invention as shown in FIG. 2.

### Example 3

### Field Test of Soil Resistant Glass Laminate

One-half of the back window of a pick-up truck topper was converted to a soil resistant laminate using a maleic/hydrophobicly modified olefin copolymer in a detergent carrier (Glass Force®, Ecolab). The other half was cleaned with the unmodified glass cleaner. The vehicle was driven for about 2 hours. As FIG. 3 demonstrates the portion of the window with the soil resistant laminate remained substantially freer of soils than the control half. Without being limited to a particular theory, the treated portion of the window comprising the soil resistant laminate remained substantially-free of soil as a result of the mechanical action of air blown on the window during the driving process.

### Example 4

### Contact Angles of Soil Resistant Glass Surface Versus Untreated Glass Surface

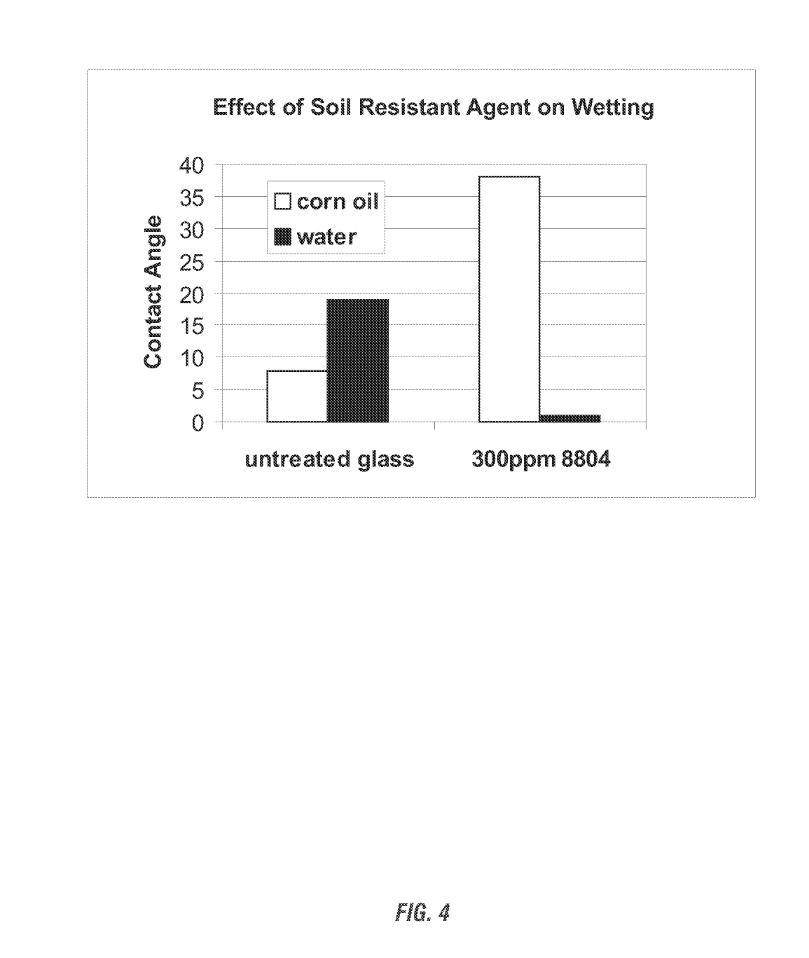

The effects of the soil resistant agent according to the invention on wetting were analyzed and measured according to the ratio of oil contact angle to water contact angle for each surface. Glass slides were treated with 300 ppm of the maleic/hydrophobicly modified olefin copolymer soil resistant and compared to untreated glass slides (control). The surfaces were contacted with both corn oil and water in order to measure the oil contact angle and water contact angle of the treated surfaces. The ratio of oil contact angle to water contact angle for the treated surface was then calculated (FIG. 4).

The ratio of oil contact angle to water contact angle for the untreated glass surface was 0.4 (oil contact angle: 8, water contact angle: 19) (control). In comparison, according to a preferred embodiment of the invention, the ratio of oil contact angle to water contact angle for the soil resistant treated glass was 38 (oil contact angle: 38, water contact angle: 1). Treated surfaces according to the invention demonstrate the “sheeting” of water and “beading” of oils contacting the treated surface. As a result, water sheets wedge underneath the soil and lift away the oil beads from the treated surface providing a soil resistant surface. These results obtained are consistent with desired composition concentrations for soil resistant applications utilizing a detergent carrier as one skilled in the art will ascertain based on the disclosure of the invention.

### Example 5

### Composition Concentrations for Soil Resistant Applications

Various concentrations of the maleic/hydrophobicly modified olefin copolymer soil resistant agent according to the invention were tested to determine the preferred polymer concentration. In addition various concentrations for the olefin copolymer soil resistant agents and the acrylate copolymer soil resistant agents were tested to determine the preferred polymer concentration.

Concentrations from about 1% to about 15% solutions of each copolymer soil resistant agent were applied to various surfaces. More concentrated solutions, such as 15% polymer solids, were observed to not sufficiently dry. In addition, the more concentrated solutions of the copolymer soil resistant did not provide desired longevity of soil resistance in the presence of water. In the alternative, extremely dilute solutions, such as less than 0.1% polymer solids, showed reduced effectiveness as a soil resistant composition on a clean surface.

Maleic/hydrophobicly modified olefin copolymers from at least 0.1% to about 5% demonstrated formation of a transparent dry-to-touch laminate as desired according to the invention.

Acrylate/olefin copolymers from at least 0.1% to about 5% demonstrated formation of a transparent dry-to-touch laminate as desired according to the invention.

These results obtained are consistent with desired composition concentrations for soil resistant applications utilizing a detergent carrier as one skilled in the art will ascertain based on the disclosure of the invention.

### Example 6

The concentrate formulations set forth in the table below were used to prepare Examples 1-16 as also set forth in the table below. Formulations 1-4 each include Polyquart Pro, a commercially available acrylic based cleaner from Cognis Corporation. Formulation 5 did not use Polyquart Pro, and experiments using Formulation 5 are labeled as comparative examples. EZ Clean 200 is an acrylic based stain resistant agent available from Dow. The various components for each concentration were combined and shaken for 15 seconds.

| | Form | Form | Form | Form | Form |
|---|---|---|---|---|---|
| Description | 1 | 2 | 3 | 4 | 5 |
| Water Deionized TNK | 45.00 | 45.00 | 45.00 | 45.00 | 45.00 |
| Polyquart Pro (22%) | 7.13 | 3.56 | 1.78 | 0.89 | 0.00 |
| Solution of tetrasodium salt of GLDA | 0.75 | 0.75 | 0.75 | 0.75 | 0.75 |
| DRM | | | | | |
| Palm Kernel Based Fatty Acid | 18.00 | 18.79 | 19.18 | 19.37 | 19.57 |
| Potassium Hydroxide, 45% Liquid | 9.12 | 9.54 | 9.73 | 9.83 | 9.93 |
| Water Deionized TNK | 20.00 | 22.37 | 23.56 | 24.16 | 24.75 |

| | | Tap | | 1% SRA | 1% EZ Clean |
|---|---|---|---|---|---|
| | | water | Form | “A” in | 200 in |
| Experi- | Formu- | by wt. | by wt | water by | water by |
| ment | lation | % | % | wt % | wt % |
| 1 | Form 1 | 222.30 | 2.70 | 0.00 | 0.00 |
| 2 | Form 2 | 222.30 | 2.70 | 0.00 | 0.00 |
| 3 | Form 3 | 222.30 | 2.70 | 0.00 | 0.00 |
| 4 | Form 4 | 222.30 | 2.70 | 0.00 | 0.00 |
| 5 | Form 5 | 222.30 | 2.70 | 0.00 | 0.00 |
| 6 | Form 1 | 211.04 | 2.70 | 11.26 | 0.00 |
| 7 | Form 2 | 211.04 | 2.70 | 11.26 | 0.00 |
| 8 | Form 3 | 211.04 | 2.70 | 11.26 | 0.00 |
| 9 | Form 4 | 211.04 | 2.70 | 11.26 | 0.00 |
| 10 | Form 5 | 211.04 | 2.70 | 11.26 | 0.00 |
| 11 | Form 1 | 216.25 | 2.70 | 0.00 | 6.05 |
| 12 | Form 2 | 216.25 | 2.70 | 0.00 | 6.05 |
| 13 | Form 3 | 216.25 | 2.70 | 0.00 | 6.05 |
| 14 | Form 4 | 216.25 | 2.70 | 0.00 | 6.05 |
| 15 | Form 5 | 216.25 | 2.70 | 0.00 | 6.05 |

| | |
|---|---|
| 16 | Water Control |

White grout coupons were prepared by mixing 19.32 wt % deionized water with 80.68 wt % PolyBlend Sanded Grout Mix, Bright White #381, which was manufactured by Custom Building products. Several “2 by 2” test coupons were formed by filling a mold with the mixture and allowing 5 to 7 days of ambient curing.

The coupons were soiled with two perpendicular passes of a foam brush coated with a black oily soil mixture. The soiled coupons were placed in a Gardner Abraser tray and submerged in 220 g of cleaning solution. Each of Experiments 1-16 was used to treat at least one soiled coupon. A yellow 33PP1 DCV sponge from Reilly Foam Corporation was loaded into the Gardner abraser carriage with no extra loaded way and the sponge was passed over the coupon for 10 cycles. The coupon was then removed and air dried for 24 hours.

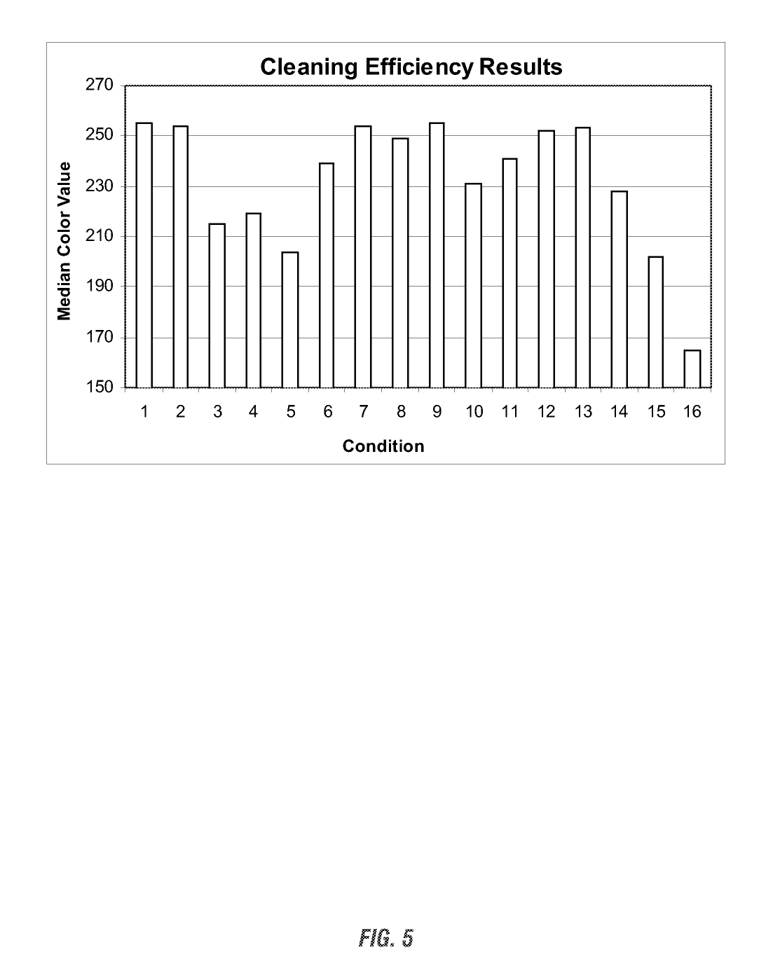

An image of each coupon was then scanned as a color “jpeg” image at 300 dpi. Fiji image analysis software was used to determine the median color values of the coupons. A higher color value indicates a whiter or cleaner surface of the coupon, meaning better cleaning performance. The results are set forth in the table below and shown in FIG. 5.

| Condition | Median Color Value |
|---|---|
| 1 | 255 |
| 2 | 254 |
| 3 | 215 |
| 4 | 219 |
| 5 | 204 |
| 6 | 239 |
| 7 | 254 |
| 8 | 249 |
| 9 | 255 |
| 10 | 231 |
| 11 | 241 |
| 12 | 252 |
| 13 | 253 |
| 14 | 228 |
| 15 | 202 |
| 16 | 165 |

A number of observations can be made from these results of the mean color values. The results demonstrate that the control (water) had the lowest cleaning efficiency overall (median color value 165). Of the compositions that included cleaner, Experiments 6-10, including a combination of Polyquart Pro and Stain Resistant Agent A had the highest overall cleaning efficiency, followed by Experiments completed with the Polyquart Pro and EZ Clean 20 and then Experiments completed with the Polyquart Pro only. The Comparative Experiments not including Polyquart Pro did not perform as well as the same Experiment with Polyquart Pro. These results demonstrate a preferred embodiment of the compositions and methods of the invention comprising both ES8804 and PolyQuart Pro (combination of a soil resistant agent and a soil release agent as described herein). The combination provides synergistic improvements in cleaning efficiency.

Additionally, the Experiments 8-9 containing ES8804 and 14-15 containing EZ Clean 200 had high cleaning efficiency despite having a reduced concentration of Polyquart Pro. In comparison, Experiments 3-4 with reduced Polyquart Pro concentrations and no ES8804 or EZ Clean 200 had significantly lower cleaning efficiency. Furthermore the two Comparative Experiments 10 and 15 containing no Polyquart Pro, but ES8804 or EZ Clean 200, had a reduced cleaning efficiency in contrast to compositions also containing Polyquart Pro. The results clearly indicated that the combination of Polyquart Pro and ES8804 or EZClean 200, at certain component concentration ranges, can significantly improve the cleaning efficiency over the compositions containing Polyquart Pro only or the soil resistant agent only, demonstrating synergistic improvements in cleaning efficiency. According to most preferred formulations the combination provides synergistic soil resistance according to the invention.

Moreover the experimental results also demonstrated that the addition of Polyquart Pro to a fatty acid based cleaner had significantly improved soil removal ability. A similar result was obtained by comparing Experiment 10 to Experiment 5 demonstrating that the addition of ES8804 to the fatty acid based cleaner significantly increased the cleaning efficiency.

Altogether, the cleaning efficiency of PolyQuart Pro is decreased when used at concentrations of less than 3.56% (conditions 3-4); however, when a second additive such as ES8804 or EZ Clean 200 is added to the system the cleaning efficiency of conditions containing less than 3.56% PolyQuart Pro is increased. In addition, combinations of PolyQuart Pro and ES8804 or EZ Clean 200 shows better cleaning efficiency than conditions containing only ES8804 or only EZ Clean 200 as well as conditions that contain no PolyQuart Pro, no ES8804 and no EZ Clean 200.

These results obtained are consistent with the use of soil resistant applications with a detergent carrier as one skilled in the art will ascertain based on the disclosure of the invention.

### Example 7

Half of glass slides were treated with 300 ppm of maleic/olefin copolymer soil resistant agent according to the invention. Each of the glass slides were air-dried and then dusted with kaolin clay. Loose clay was removed by tapping each slide three times. Soil release agents were compared for efficacy and formation of a soil resistant laminate with the surface. Although a water carrier was utilized for the compositions, this screening analysis is expected to yield the same results for soil resistance for those compositions having a detergent carrier as one skilled in the art will ascertain based on the disclosure of the invention.

The various copolymers were examined to show that some polymers acted as a soil attractant and caused more clay to adhere to the treated area than the untreated area. Although not intending to be limited to a particular theory, the effects of attracting soil by some agents was indicative of the mechanism of action of certain soil release agents (e.g. treated surface becomes sticky which attracts soils but allows for easily wiping the surface to remove soils).

In contrast, the area treated with the olefin copolymer soil resistant agent according to the invention interfered with adhesion of the clay and left the treated area significantly cleaner than the untreated area, demonstrating the benefit of the present invention as a glass laminate for soil resistance over existing art.

Comparisons of various tested copolymers are shown below.

| Excellent | Moderate | | Attracted |
|---|---|---|---|
| Resistance | Resistance | No Effect | Soil |
| ES8804 | Sokalan PM 101 | Sokalan PM 70 | Jaypol 871 |
| Acusol 460 | Aquatreat AR-545 | Acusol 544 | Jaypol 872 |
| Sokalan CP9 | Acusol 820 | Acusol 445 | Gantrez S-95 |
| Acusol 929 | Acusol944 | Sokalan CP44 | Acusol 5240 |
| | Acusol 805S | Alcosperse 125 | Solalan PA30CL |
| | Sokalan CP42 | Acusol 448 | Polyquart Pro |
| | Acusol 801 | Acumer 2100 | |
| | Acusol 441 | Versaflex 1 | |
| | Acusol 505 | Dequest | |
| | Sokalan PA15 | 2010-10-06 | |
| | Acusol 588 | Bayhibit AM | |
| | Sokalan PM10 | | |
| | Acusol 587 | | |
| | Acumer 2000 | | |
| | Acusol 588 | | |
| | Aquatreat AR-6 | | |
| | Alcosperse 747 | | |
| | Acumer 3100 | | |
| | Acumer 1480 | | |
| | Acumer 5242 | | |
| | Belclene 200 | | |
| | Acumer 1510 | | |
| | Versa TL-4 | | |
| | Acumer 5000 | | |
| | Aquatreat AR-200 | | |
| | Sokalan PM15 | | |
| | Sokalan CP50 | | |

The above-tested commercially-available polymers and copolymers which may be further suitable for use as a soil resistant copolymer include: Acusol 929, polyacrylate (trademark of Rohm & Haas, now Dow Chemical Company); Sokalan CP-9 a maleic acid/olefin copolymer sodium salt, Acusol 460, and ES8804 (aka 8804). However, Acusol 460 is a threshold agent and therefore not desirable for use in a cured film on a solid substrate. Sokalan PM 10/Sokalan PM 15/Sokalan CP42/Sokalan CP50, modified polycarboxylates, Sokalan PA15, polyacrylic acid, sodium salt (trademarks of BASF); Belclene 200, polymaleic acid copolymer (trademark of BWA Water Additives); Versa TL-4,2,5-furandione with sulfonated styrene, sodium salt (trademark of Akzo-Nobel); Aquatreat AR-545, acrylic acid/2-acrylamido-2-methlpropane, Aquatreat AR-6, polyacrylic acid, Aquatreat AR-200, unknown structure (trademarks of Akzo-Nobel); Alcosperse 747, hydrophobically modified copolymer of undefined structure showed slight activity as soil release agents. However, these materials are threshold agents for use in water and therefore not desirable as soil resistance agents. Alcosperse 125, acrylate polymer (trademarks of Akzo-Nobel); Acusol polymers (trademarks of Dow Chemical Company). Sokalan PM 70, Acusol 544, Acusol 445, Sokalan CP44, Alcosperse 125, Acusol 448, Acumer 2100, Versaflex 1, Dequest 2010, and Bayhibit AM did not show activity as soil resistant agents. Jaypol 871, Jaypol 872, Gantrez S-95, Acusol 5240, Solalan PA30CL, and Polyquart Pro increased the extent of soiling when applied to a clean hard surface.

Preferred embodiments of the invention include compositions and methods employing compositions using a soil resistant agent selected from the group consisting of commercially-available soil resistant agents ES8804, Sokalan CP9, and combinations thereof. In addition, as described according to an embodiment of the invention, Polyquart Pro (soil release agent from Cognis Corporation) may further be combined with the soil resistant agents for improved and/or synergistic soil resistance.

Preferably, according to the invention the soil resistant agent does not include an agent selected from the group consisting of commercially-available products Jaypol 871, Jaypol 872, Gantrez S-95, Acusol 5240, Sokalan PA30CL and combinations thereof.

Still further preferably, according to the invention the soil resistant agent does not include an agent selected from the group consisting of commercially-available products Sokalan PM, Acusol 544, Acusol 445, Sokalan CP44, Alcosperse 125, Acusol 448, Acumer 2100, Versaflex 1, Dequest 2010, Bayhibit AM and combinations thereof.

The inventions being thus described, it will be obvious that the same may be varied in many ways. Such variations are not to be regarded as a departure from the spirit and scope of the inventions and all such modifications are intended to be included within the scope of the following claims.

The methods and compositions of the present invention can comprise, consist of, or consist essentially of the listed steps or ingredients. As used herein the term “consisting essentially of” shall be construed to mean including the listed ingredients or steps and such additional ingredients or steps which do not materially affect the basic and novel properties of the composition or method. In some embodiments, a composition in accordance with embodiments of the present invention that “consists essentially of” the recited ingredients does not include any additional ingredients that alter the basic and novel properties of the composition.

What is claimed is:

1. A soil resistant laminate composition comprising:
a multilayer composition comprising:
a clean or soiled surface as a bottom layer; and
a dried polymer layer disposed as a top layer on said surface, wherein said polymer layer is obtained from a solution comprising from about 0.005 wt % to about 20 wt % of at least one soil resistant agent having a molecular weight from about 1,000 to about 20,000 g/mol and a detergent carrier.

2. The composition according to claim 1 wherein said soil resistant agent is selected from copolymers from the group consisting of a maleic/olefin, an olefin/acrylate and combinations thereof.

3. The composition according to claim 1 wherein said soil resistant agent is substantially free of fluorinated or silicone substituents and/or is modified such that no viscosity-building or threshold activity is exhibited.

4. The composition according to claim 2 wherein said molecular weight is from about 2,000 to about 10,000 g/mol and said olefin polymers are hydrophobicly modified.

5. The composition according to claim 2 wherein said soil resistant agent is an olefin/acrylate copolymer wherein the olefin is selected from the group consisting of ethylene, propylene, butylene, isobutylene and combinations thereof.

6. The composition according to claim 2 wherein said soil resistant agent is a maleic/olefin copolymer having a maleic/olefin ratio from about 1:4 to 4:1.

7. The composition according to claim 1 wherein said laminate composition surface has an oil/water contact angle ratio of at least 2.

8. The composition according to claim 1 further comprising an amphoteric acrylic copolymer soil release agent and wherein said surface is a substrate selected from the group consisting of glass, fiberglass, concrete, ceramic, porcelain, plastic, rubber, metals, paint, a cured polymeric coating and combinations thereof.

9. A soil resistant use composition comprising:
about 0.005 wt % to about 20 wt % of a soil resistant agent selected from co-polymers from the group consisting of a maleic/olefin, an olefin/acrylate and combinations thereof having a molecular weight from about 1,000 to 20,000 g/mol;
about 0.005 wt % to about 20 wt % of at least one amphoteric acrylic copolymer soil release agent; and
a detergent carrier.

10. The composition according to claim 9 wherein said soil resistant agent is a copolymer of maleic/olefin having a ratio of acrylic to maleic moieties from about 0.02:1 to 5:1.

11. The composition according to claim 9 wherein the ratio of the acrylic to the maleic moieties is from about 0.05:1 to 1:1.

12. The composition according to claim 9 wherein said composition is substantially free of fluorinated or silicone substituents and said copolymer of maleic/olefin is modified such that no viscosity-building or threshold activity is exhibited.

13. The composition according to claim 9 wherein said oil/water contact angle ratio of a surface treated with said composition is at least 2.

14. The composition according to claim 13 wherein said oil/water contact angle ratio of the laminate layer is at least 4.

15. The composition according to claim 9 wherein said soil resistant agent is a maleic/olefin copolymer molecular weight is from about 2,000 to 5,000 g/mol and has a maleic/olefin ratio from about 1:2 to 2:1.

16. A kit comprising:
a soil resistant treatment composition according to claim 9;
an applicator; and
instructions for use of said kit.

17. A method for treating a clean or soiled hard (wherein the hard surface can be porous or non-porous) surface comprising:
applying to a clean or soiled surface an aqueous solution comprising from about 0.005 wt % to about 20 wt % of a soil resistant agent selected from copolymers from the group consisting of a maleic/olefin, an olefin/acrylate and combinations thereof, wherein said soil resistant agent has a molecular weight from about 1,000 to 20,000 g/mol; and
forming a dried laminate layer of said soil resistant agent over said surface, wherein said laminate layer has an oil/water contact angle ratio of at least 2.

18. The method according to claim 17 further comprising the step of first diluting said soil resistant agent with a detergent carrier before applying said composition to said surface.

19. The method according to claim 17 further comprising the step of allowing said laminate layer to dry and form an invisible film and cleaning said treated surface after a period of time with compressed air and without a source of water to remove soils.

20. The method according to claim 17 wherein said soil resistant agent has a molecular weight is from about 2,000 to 5,000 g/mol and is substantially free of fluorinated or silicone substituents, and wherein said oil/water contact angle ratio is at least 6.

21. The method according to claim 17 further comprising cleaning said treated surface after a period of time without a source of water, and wherein said surface is a substrate selected from the group consisting of glass, concrete, porcelain, ceramic, fiberglass, plastic, rubber, metals, paint, a cured polymeric coating and combinations thereof, and wherein said removal of soil step includes application of a water source and/or mechanical force.

22. The method according to claim 17 further comprising adding an amphoteric acrylic copolymer soil release agent to said aqueous solution.
